(19) United States
(12) Patent Application Publication
(10) Pub. No.: US 2010/0228811 A1
(43) Pub. Date: Sep. 9, 2010

(54) System and method for managing data transfer

(75) Inventors: Kyle Prestenback, Burbank, CA (US); Jeff Ashbrook, Burbank, CA (US); Evan Tahler, Burbank, CA (US); Aaron Daly, Valley Village, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/381,265

(22) Filed: Mar. 9, 2009

(51) Int. Cl. G06F 15/16

(52) U.S. Cl. 709/203

(57) ABSTRACT

There is provided a media playback device for accessing first and second server-side applications via a communications network and managing data transfer via client-side applications. The media playback device includes a memory configured to store first and second client-side applications corresponding to the first and second server-side applications. The media playback device includes a processor configured to launch the first client-side application, request first data for use by the first client-side application, transfer the first data by the first client-side application to the first server-side application, and store the first data in the memory. The processor is further configured to receive an input requesting launch of the second client-side application, launch the second client-side application, identify the first data for use by the second client-side application, and read the first data from the memory into the second client-side application.

### BACKGROUND OF THE INVENTION

1. Field of the Invention

The present invention relates generally to data transfer. More particularly, the present invention relates to the controlled transfer of data between client-side software applications.

2. Background Art

Even the most technology indifferent mobile telephone user is now likely to recognize that, their handset may be nifty, but the applications software, or “apps,” are where the fun is. There are now applications for social networking, applications for gaming, applications for managing music content, even applications for navigating content provided by local public broadcasters, and the list goes on and on. Although software applications for use on mobile devices are presently very popular, they represent only a portion of the applications that most consumers now use routinely, often without any direct awareness of their functionality, on such devices as personal computers, gaming systems, and optical media presentation devices such as Blu-ray players.

As software applications have become more complex and sophisticated in their ability to generate and manage data, so too have they become increasingly focused in their user implementations. In other words, just as social forces tend to encourage specialization of human effort in advanced societies, market forces have encouraged specialization of expertise in the rapidly evolving and highly competitive area of information management. As a result, different types of applications are increasingly likely to process, e.g., obtain, store, maintain, and coordinate certain types of information more efficiently than others, and this may be especially true for applications mediating user interaction over a communications network. For example, a social networking application may serve as a comprehensive and user friendly resource for managing and sharing personal information on the web, but the specialized features developed to provide those advantages may be less well suited to support an alternative network functionality, such as hosting a real-time Internet based gaming environment.

Despite the increasing specialization of software applications, however, some data may be useful across a spectrum of different application functionalities. In particular, for applications running on a shared computing platform, data such as login information, screen names, session data, and the like, may be needed or useful for more than one application. In the past, when applications were simpler and less specialized, a single applications provider was frequently the source of many of the applications utilized on a shared platform, so that data would typically be exchanged among those commonly owned or commonly sourced applications.

Increasingly, however, specialization of expertise in software functionality now extends to the producers and vendors of the applications delivering that functionality, as well to the software products themselves. Consequently, it is now often the case that software applications populating the same computing platform are designed and produced by independent commercial entities, each with their own propriety interests to protect. As a result, those separately owned or sourced applications may be effectively independent, and may not be configured to share data cooperatively.

One possible solution for providing more than one software application, for example two applications, with data that is commonly useful to both, is to permit one or both applications to access data held by the other. As mentioned, however, for proprietary and/or security reasons, that is no longer an attractive option for software application developers. Another possible solution is for each application to obtain the data independently. Although this latter solution successfully avoids any security risks or proprietary associated with sharing information between applications, it introduces significant disadvantages of its own.

One disadvantage associated with having each application obtain commonly needed data for itself is that this solution fails to make use of the distinct information management efficiencies of the different applications. For example, requiring a gaming application to obtain personal login information or a friends list for group gaming, independently of a social networking application already in possession of that information and better suited to manage it, is redundant and inefficient. Perhaps even more importantly, the duplicative request for data previously entered into the system can cause the user considerable frustration and delay in accessing and enjoying a group gaming experience. Extending that user experience to multiple applications requiring similar data, this approach quickly becomes impracticable. Moreover, in some instances, data may not be available without some cooperation between the applications. For example, there may be advantages to having state or session data handed off from one application to another, to support a seamless user experience in transitioning between independent applications.

Accordingly, there is a need to overcome the drawbacks and deficiencies in the art by providing a solution enabling controlled transfer of data, such as state, session, or user data, for example, between independent software applications running on a shared platform.

### SUMMARY OF THE INVENTION

There are provided systems and methods for managing data transfer, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a high-level block diagram of a system for managing data transfer, according to one embodiment of the present invention;

FIG. 2 shows a more detailed example of a system for managing data transfer, according to one embodiment of the present invention; and

FIG. 3 is a flowchart presenting a method of managing data transfer, according to one embodiment of the present invention.

### DETAILED DESCRIPTION OF THE INVENTION

The present application is directed to a system and method for managing data transfer via independent client-side software applications. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

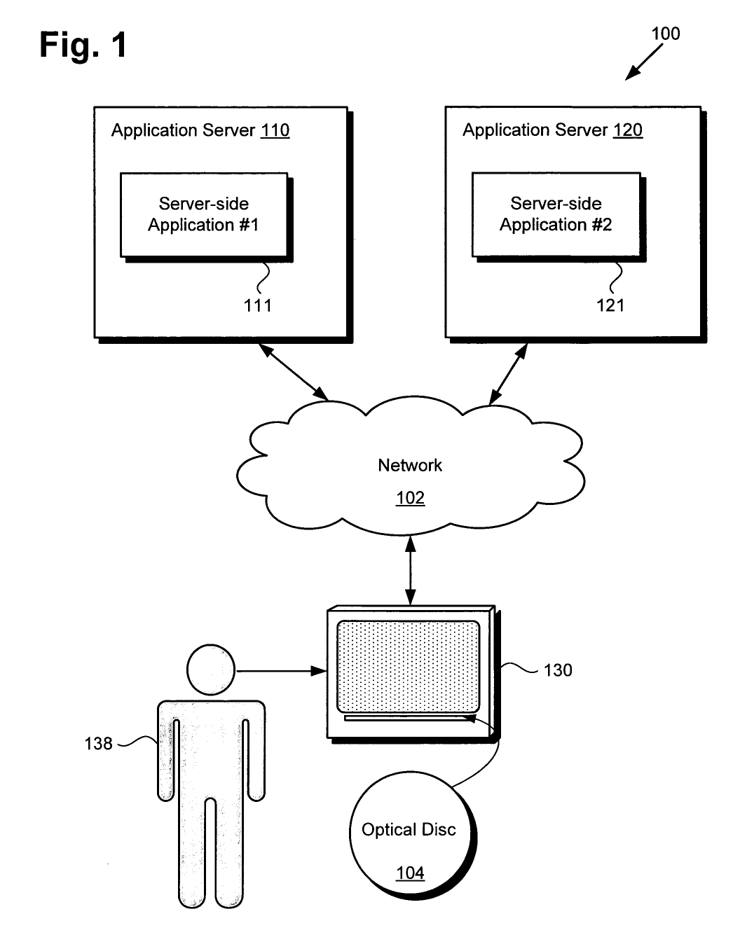

FIG. 1 shows a high-level block diagram of system 100 for managing data transfer, according to one embodiment of the present invention. In the embodiment of FIG. 1, system 100 comprises media playback device 130. Also shown in FIG. 1 are application server 110 hosting server-side application 111, application server 120 hosting server-side application 121, and network 102 mediating communications between media playback device 130 and application servers 110 and 120. In addition, FIG. 1 shows user 138 and exemplary optical disc 104, which may be a high-definition (HD) optical disc, such as a Blu-ray disc, for example, for playback on media playback device 130.

As shown in FIG. 1, media playback device 130 media playback device 130 is configured to access server-side application 111 and server-side application 121 via network 102, which may be any suitable communication network. Media playback device 130 is further configured to provide controlled transfer of data from a first client-side application corresponding to server-side application 111, to a second client-side application corresponding to server-side application 121, and/or vice versa (first and second client-side applications not shown in FIG. 1). As a result, user 138 may enjoy substantially seamless interaction across server-side applications 111 and 121 without direct server-side transfer of data, such as personal user data, or session data, for example.

It may be apparent from FIG. 1 that according to the present embodiment, media playback device 130 is represented as an entertainment system configured for network access, and including an optical disc player such as a Blu-ray disc player. The present representation is merely exemplary, however, and in other embodiments, media playback device 130 may be another type of personal communication system such as a mobile telephone, a digital media player, personal digital assistant (PDA), a personal computer (PC), or a gaming console, for example.

As shown in FIG. 1, server-side applications 111 and 121 may be accessed via network 102. In that instance, server-side applications 111 and 121 may comprise web applications, accessible over a packet network such as the Internet. Alternatively, server-side applications 111 and 121 may reside on one or more servers supporting a local area network (LAN), for instance, or included in another type of limited distribution network. Although the embodiment of FIG. 1 shows server-side applications 111 and 121 hosted by distinct respective application servers 110 and 120, in other embodiments, server-side applications 111 and 121 may be independent applications hosted by a single server corresponding to either of application servers 110 or 120.

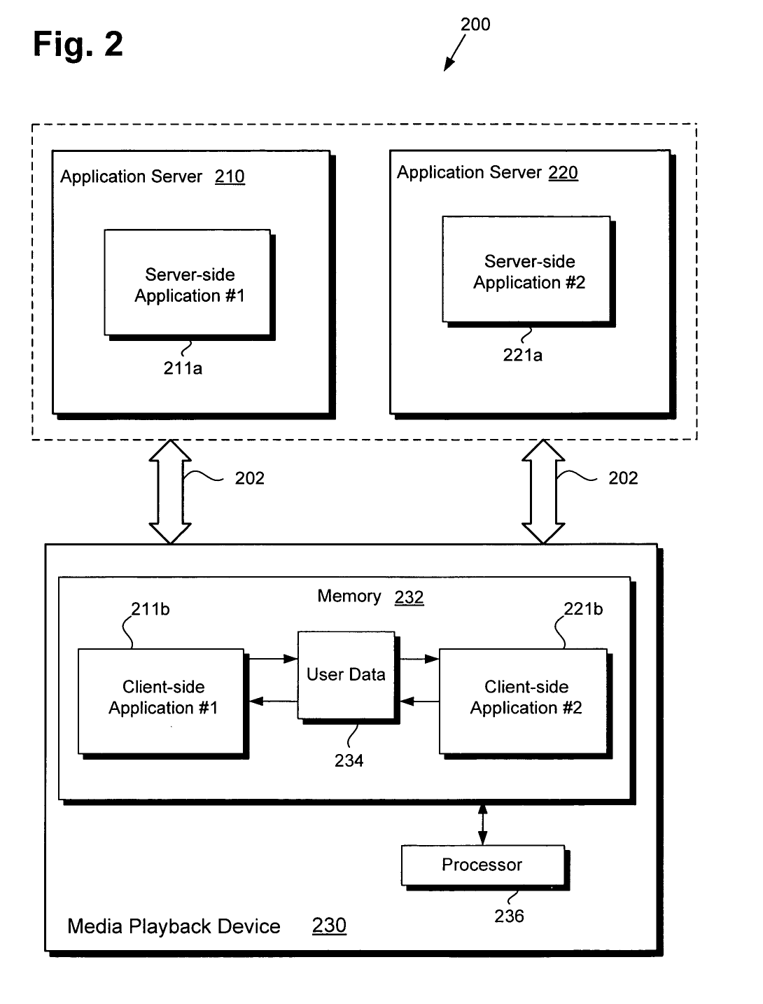

Turning now to FIG. 2, FIG. 2 shows a more detailed example of system 200 for managing data transfer via independent client-side applications, according to one embodiment of the present invention. System 200, in FIG. 2, comprises media playback device 230, including memory 232 and processor 236. Also shown in FIG. 2 are application server 210 hosting server-side application 211a, application server 220 hosting server-side application 221a, and network communication links 202.

Media playback device 230, application server 210 hosting server-side application 211a, and application server 220 hosting server-side application 221a, in FIG. 2, correspond respectively to media playback device 130, application server 110 hosting server-side application 111, and application server 120 hosting server-side application 121, in FIG. 1. Network communication links 202, in FIG. 2, correspond to communication through network 102, shown in FIG. 1. It is noted that the dashed enclosure surrounding application servers 210 and 220, in FIG. 2, is present merely to emphasize that, in some embodiments, server-side applications 211a and 211b may be independent applications residing on a common application server.

As shown in FIG. 2, media playback device 230 is configured to access server-side applications 211a and 221a via network communications links 202. Memory 232 of media playback device 230 is shown to hold client-side application 211b, exemplary user data 234, and client-side application 221b. Client-side applications 211b and 221b correspond respectively to server-side applications 211a and 211b, and although discussed in relation to FIG. 1, were not shown in that previous figure. User data 234 is shown as exemplary data to be transferred between client-side applications 211b and 221b via media playback device 230. For example, in various representations of system 200, data corresponding to user data 234 might include state data of either of client-side applications 211b and 221b, session data for either or both client-side applications, or any other data received or generated by one of the client-side applications, and usable by the other client-side application.

Client-side application 211b corresponding to server-side application 211a, and/or client-side application 221b corresponding to server-side application 221a may be loaded into memory 232 from a computer-readable medium utilized by media playback device 230. For example, where media playback device 230 is an optical disc player, such as a Blu-ray player, for example, client-side applications 211a and/or 221b may be acquired from the Blu-ray disc. Alternatively, in some embodiments, one or both client-side application 211b and client-side application 221b may be transferred from a networked source via network communication links 202, such as through download from application server 210 or 220, for example.

Processor 236 may be the central processing unit for media playback device 230, for example, in which role processor 236 runs the media playback device firmware and/or operating system, manages exemplary user data 234, and facilitates execution of client-side applications 211b and 221b. In addition, processor 236 is configured to execute operations corresponding to method steps for managing transfer of commonly useful data, such as user data 234, from client-side application 211b to client-side application 221b, or vice versa. Moreover, in one embodiment, processor 236 is configured to perform that transfer between mutually independent client-side applications 211b and 221b via media playback device 230, without there being direct transfer of data between corresponding respective server-side applications 211a and 211b. As a result, media playback device 230 advantageously enables controlled data transfer between the client-side applications while preserving data security and proprietary controls for the client-side and server-side applications.

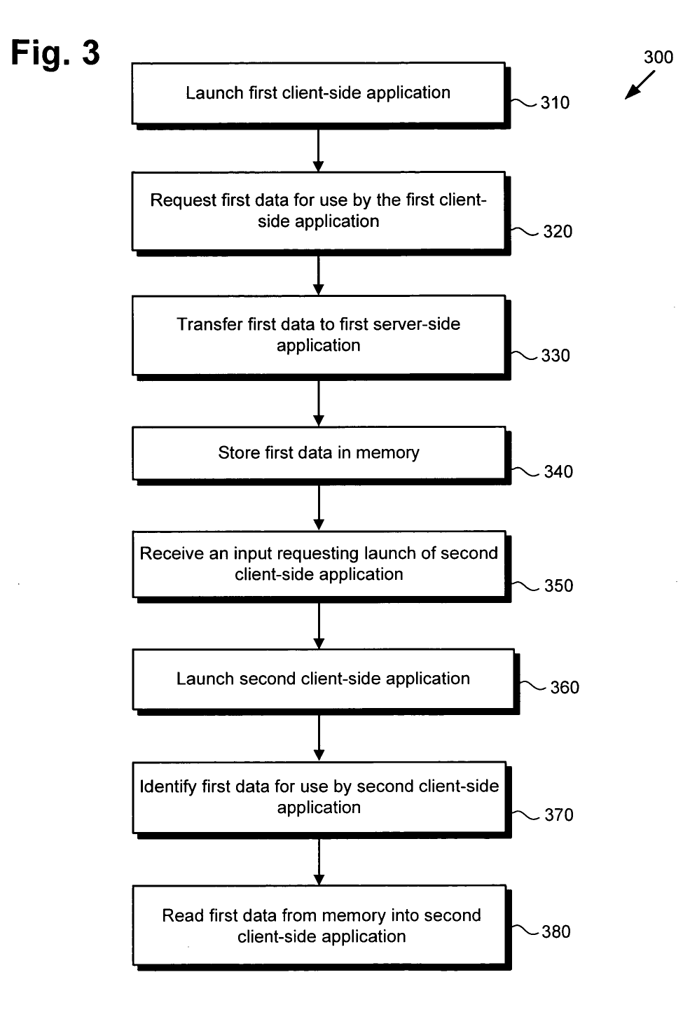

The functionality and advantages attributable to systems 100 and 200 will now be further described in conjunction with FIG. 3, which presents flowchart 300 describing a method of managing data transfer via independent client-side applications, according to one embodiment of the present invention. More specifically, the example method of flowchart 300 presents a method for accessing first and second server-side applications via a communications network and managing data transfer via client-side applications. The steps shown in flowchart 300 are merely exemplary, however, so that a step may consist of one or more substeps or may involve specialized equipment or materials, as known in the art. While steps 310 through 380 indicated in flowchart 300 are sufficient to describe one embodiment of the present invention, other embodiments may utilize steps different from those shown in flowchart 300, or may include more, or fewer steps.

Turning to step 310 of flowchart 300 and referring to FIG. 2, step 310 comprises launching the first client-side application. As shown in FIG. 2, client-side application 211b and client-side application 221b are stored in memory 232 of media playback device 230. Step 310 may be performed by processor 236, and corresponds to launching one of client-side applications 211b and 221b. It is worth noting that either of client-side applications 211b or 221b may be viewed as the first client-side application, or as the second client-side application. In the interest of clarity in describing the present method, however, client-side application 211b shall assume the role of first client-side application, and client-side application 221b shall henceforth correspond to the second client-side application. Thus, according to the embodiment of FIG. 2, step 310 corresponds to launch of client-side application 211b by processor 236.

As previously mentioned, client-side application 211b corresponds to server-side application 211a, and client side application 221b corresponds to server-side application 221a. Server side-applications 211a and 221a may represent any two independent network based applications, and client-side applications 211b and 221b their respective clients, for example. In one embodiment, server-side application 211a or 221a may comprise a social network, so that respective client-side application 211b or 221b can be a client-side social networking application mediating user interaction with the social network. In another embodiment, server-side application 211a or 221a may comprise a network based game, such as a multi-player Internet trivia game, for example. In that latter embodiment, respective client-side application 211b or 221b can be a client-side gaming application mediating user participation in the multi-player Internet game.

Continuing with step 320 of flowchart 300, and also continuing to refer to FIG. 2, step 320 comprises requesting first data for use by the first client-side application, e.g., client-side application 211b. Step 320 may be performed by processor 236, for example, and may comprise requesting login data, such as a username or password, from a user through a query generated by client-side application 211b. Although the present method describes requesting first data, that should not be construed as a limitation. For example, it is envisioned that in some embodiments step 320 may comprise requesting multiple data in addition to the first data described here. The first data of step 320 is represented in FIG. 2 by user data 234. In other embodiments, however, the first data may comprise data other than user data.

Step 330 of flowchart 300 comprises transferring the first data, such as user data 234, to the server-side application corresponding to client-side application 211b, e.g., server-side application 211a. Step 330 may be controlled by processor 236, and include transfer of user data 234 by client-side application 211b over network link 202, for example. In step 340, user data 234 is stored in memory 232, as shown in FIG. 2. Storage of user data 234 on media playback device 230 may be performed by processor 236. In one embodiment, the present method may further comprise receiving the first data, e.g., user data 234, from server-side application 211a prior to storing the first data in step 340.

The method of flowchart 300 continues with step 350, which comprises receiving an input requesting launch of the second client-side application, e.g., client-side application 221b. Step 350 may correspond to receipt of a user input by processor 236, resulting from interaction of the user with client-side application 211b, for example.

Moving now to step 360 of flowchart 300, step 360 comprises launching the second client-side application. In system 200 of FIG. 2, step 360 may be performed by processor 236, and corresponds to launch of client-side application 221b. In some embodiments, processor 236 may be configured to stop client-application 211b prior to launching client-side application 221b, so that the first and the second client-side applications are not running concurrently. In other embodiments, however, it may be advantageous or desirable to launch client-side application 221b prior to stopping client-side application 211b. In still other embodiments, both client-side applications may be active concurrently.

Continuing with step 370 of flowchart 300 and also continuing to refer to FIG. 2, step 370 comprises identifying the first data for use by the second client-side application, e.g., client-side application 221b. Step 370 may be performed by processor 236, for example, and may comprise identifying a code corresponding to information entered by the user in response to a query generated by client-side application 211b. As previously explained, although the present method describes identifying first data, that should not be construed as a limitation. For example, it is envisioned that in some embodiments step 320 may comprise identifying multiple data, such as codes, in addition to the first data recited in step 370. As further noted previously, the first data is represented in FIG. 2 by user data 234. In other embodiments, however, the first data may comprise data other than user data, such as state data, or session data.

As one specific example of the first data identified in step 370, consider the situation in which client-side application 211b corresponds to a first online game, and client-side application 221b corresponds to a second online game that uses a player's past performance in the first game as a guide to configure, or personalize, the second game to the player's skill level. In that specific instance, the first data may comprise a code representing the user's performance rating with respect to the first game. Alternatively, where configuration of the second game is enhanced by user progress through a series of challenges in the first game, the first data may correspond to state data indicating the extent to which the user has advanced through the first game before transitioning to the second game. As another alternative, the client-side application 211b might correspond to a social network from which the user elects to launch client-side application 221b corresponding to an online multi-player game. In that latter instance, the first data may comprise, for example, user data such as login data, a screen name of the user, a friends list of the user for initiation of a group gaming session, or a graphical image such as an avatar associated with a network persona of the user.

In yet other embodiments, the first data may comprise a content filtering data associated with the user. For example, where the user is a minor for whom parental controls have been assigned, the first data may comprise a code informing client-side application 221b of content access restrictions associated with the user. In the gaming or entertainment context, for example, identification of such a first data may be used to protect the user from exposure to unsuitable adult content by the second client-side application. The first data may also comprise session data, so that transition from client-side application 211b to client-side application 222b is transparent to the user. That is to say, the media playback device 230 is able, through transfer of session data, to produce a front-end experience in which the user perceives client-side application 211b and client-side application 221b as participating cooperatively in a single seamless user session, despite those client-side applications being independent of one another.

Continuing with step 380 of flowchart 300, step 380 comprises reading the first data from memory into the second client-side application. Once again, step 380 may be performed by processor 236. In the embodiment of FIG. 2, step 380 corresponds to reading user data 234 into client-side application 221b from memory 232. As previously explained, user data 234 may correspond to a variety of data for facilitating user transition from client-side application 211b to client-side application 221b. As a result of the foregoing steps, the method of flowchart 300 and system 200 can achieve transfer of data usable by both of client-side applications 211b and 221b from one application to the other, without direct transfer of data between their corresponding server-side applications.

In embodiments in which client-side application 211b is stopped prior to termination of client-side application 221b, the method of flowchart 300 may further comprise resuming client-side application 211b at that time. In some embodiments, the present method may further comprise transferring the first data to the second server-side application. Such a step might be performed by the second client-side application, e.g., client-side application 221b, under the control of processor 236, for example. In the embodiment of FIG. 2, that step might correspond to transfer of user data 234 from client-side application 221b to server-side application 221a, over network link 202.

Moreover, in some embodiments, the present method may further comprise transferring a second data from the second client-side application, e.g., client-side application 221b, to the first client-side application, e.g., client-side application 211b. That additional controlled data transfer may be performed by processor 236 through execution of steps analogous to steps 310 through 380 and further advantageously proceeds without direct data transfer between server-side applications 221a and 211a.

Thus, the present application discloses a system and method for managing data transfer. From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A media playback device for accessing first and second server-side applications via a communications network and managing data transfer via client-side applications, the media playback device comprising:
a memory configured to store first and second client-side applications corresponding respectively to the first and second server-side applications;
a processor configured to:
launch the first client-side application;
request first data for use by the first client-side application;
transfer the first data by the first client-side application to the first server-side application;
store the first data in the memory;
receive an input requesting launch of the second client-side application;
launch the second client-side application in response to the input;
identify the first data for use by the second client-side application; and
read the first data from the memory into the second client-side application.

2. The media playback device of claim 1, wherein the processor is further configured to transfer the first data by the second client-side application to the second server-side application.

3. The media playback device of claim 1, wherein the processor is further configured to stop the first client-side application before launching the second client-side application.

4. The media playback device of claim 1, wherein the first data comprises a session data such that the media playback device produces a front-end experience in which a user perceives the first client-side application and the second client-side application as participating in a single seamless user session.

5. The media playback device of claim 1, wherein the processor is further configured to resume the first client-side application upon termination of the second client-side application.

6. The media playback device of claim 1, wherein the media playback device is further configured to transfer a second data from the second to the first client-side application.

7. The media playback device of claim 1, wherein the media playback device comprises a Blu-ray player.

8. The media playback device of claim 1, wherein the first client-side application is one of a social networking application and a gaming application for a network based game.

9. The media playback device of claim 1, wherein the first data is one of a screen-name of a user, a friends list of the user, and a graphical image corresponding to the screen-name of the user.

10. The media playback device of claim 1, wherein the first data comprises a content filtering data associated with a user.

11. A method for execution by a media playback device to access first and second server-side applications via a communications network and managing data transfer via client-side applications, the method comprising:
launching the first client-side application;
requesting first data for use by the first client-side application;
transferring the first data by the first client-side application to the second client-side application;
storing the data in a memory of the media playback device;
receiving an input requesting launch of the second client-side application;
launching the second client-side application in response to the input;
identifying the first data for use by the second client-side application; and
reading the first data from the memory into the second client-side application.

12. The method of claim 11, further comprising transferring the first data by the second client-side application to the second server-side application.

13. The method of claim 11, further comprising stopping the first client-side application before launching the second client-side application.

14. The method of claim 11, wherein the first data comprises a session data such that the method results in a front-end experience in which a user perceives the first client-side application and the second client-side application as participating in a single seamless user session.

15. The method of claim 11, further comprising resuming the first client-side application upon termination of the second client-side application.

16. The method of claim 11, further comprising transferring a second data from the second to the first client-side application.

17. The method of claim 11, wherein the media playback device comprises a Blu-ray player.

18. The method of claim 11, wherein the first client-side application is one of a social networking application and a gaming application for a network based game.

19. The method of claim 11, wherein the first data is one of a screen-name of a user, a friends list of the user, and a graphical image corresponding to the screen-name of the user.

20. The method of claim 11, wherein the first data comprises a content filtering data associated with a user.
